(19) United States
(12) Patent Application Publication
(10) Pub. No.: US 2008/0046448 A1
(43) Pub. Date: Feb. 21, 2008

(54) Method and apparatus for storing contents according to attribute of storage space

(75) Inventor: Sang-jun Han, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/715,455

(22) Filed: Mar. 8, 2007

(30) Foreign Application Priority Data
Aug. 17, 2006 (KR) 10-2006-0077778

(51) Int. Cl. G06F 7/00

(52) U.S. Cl. 707/100

(57) ABSTRACT

A method and apparatus for storing contents according to an attribute of a storage space designated by a user are provided. The method of storing contents according to an attribute of a storage space, includes: receiving input attribute information on sizes and uses of a plurality of regions; partitioning the storage space into the plurality of regions according to the input attribute information for each of the plurality of regions; determining a region in which the contents are to be stored according to the attribute information of each of the plurality of regions; and storing the contents in the determined region.

### CROSS-REFERENCE TO RELATED PATENT APPLICATION

This application claims priority from Korean Patent Application No. 10-2006-0077778, filed on Aug. 17, 2006, in the Korean Intellectual Property Office, the disclosure of which is incorporated herein in its entirety by reference.

### BACKGROUND OF THE INVENTION

1. Field of the Invention

Methods and apparatuses consistent with the present invention relate to contents storage, and more particularly, to storing contents according to an attribute of a storage space designated by a user.

2. Description of the Related Art

In related art, manual and automatic updating schemes are used as a method of storing or downloading contents in a storage space of a portable multimedia player. In a manual updating scheme, a user directly selects the contents so that the contents are transmitted to the portable multimedia player and stored therein. In an automatic updating scheme, the contents are arbitrarily selected by updating software, or contents suitable for a condition designated in advance by the user are automatically prepared. After that, the contents are transmitted to the portable multimedia player and stored therein.

In the aforementioned updating schemes, since the user selects only one of the manual and automatic updating schemes, the two schemes cannot be simultaneously used to update the contents of the portable multimedia player.

In addition, since weighting factors cannot be allocated to the selection conditions designated by the user, the contents cannot be updated accurately according to user's intention or preference.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a method and apparatus for storing contents allocated with updating weight factors capable of simultaneously using manual and automatic updating schemes according to user's intention to improve an automatic contents updating function.

According to an aspect of the present invention, there is provided a method of storing contents according to an attribute of a storage space, including: receiving input attribute information on a size and a use of at least one partitioned region; partitioning the storage space into a plurality of regions according to the input attribute information; determining a region in which the contents are to be stored according to the attribute of each of the plurality of regions; and storing the contents in the determined region.

The partitioning may further include designating at least one of the regions as an automatic-updating region. In addition, the designating of at least one of the region as an automatic-updating region may further comprise designating selection conditions of the contents which are to be stored in the automatic-updating region.

In addition, the determining a region in which the contents are to be stored may include: acquiring an attribute of the contents with reference to meta data of the contents; and determining which region has the selection conditions that the acquired attributes of the contents are suitable for. In addition, the selection conditions of the to-be-stored contents may be conditions using at least one of date of issue, title, name of album, size, genre, and artist.

Further, the determining of the region in which the contents are to be stored may include: acquiring attributes of contents by analyzing details of the contents; and determining which region has the selection conditions that the acquired attributes of the contents are suitable for. The selection conditions of the to-be-stored contents may be conditions using at least one of mood, color, and composition.

The partitioning may include designating at least one of the regions as a manual-updating region. The designating at least one of the regions as a manual-updating region may include determining that the contents manually selected by a user are stored in the manual-updating region.

The determining of the to-be-stored region may include: detecting a connection to an apparatus having the partitioned storage space; and determining to-be-updated contents from the contents stored in a contents storing unit and a region in which the to-be-updated contents are stored according to the attributes of the regions, and the storing of the contents may include transmitting information on the region in which the to-be-updated contents are stored and the to-be-updated contents to the connected apparatus.

The transmitting of the contents further may include determining the to-be-updated contents so as for the contents having a size smaller than a size of each region to be stored in the corresponding region.

According to another aspect of the present invention, there is provided an information recording medium including at least one automatic-updating region for storing contents which are automatically determined according to sizes and selection conditions of the contents, wherein the sizes and selection conditions of the contents are designated by a user.

The information storage medium may further include a manual-updating region for storing contents which are selected by the user.

According to another aspect of the present invention, there is provided an apparatus for storing contents according to an attribute of a storage space, including: a first communication unit that is used for communication to a device having the storage space; a contents storing unit that stores the contents; an input unit that is used for inputting attribute information on a size and a use of at least one partitioned regions; and a control unit that partitions the storage space into the at least one partitioned regions according to the attribute information input through the input unit, determines to-be-updated contents among the contents stored in the contents storing unit and a region in which the to-be-updated contents are to be stored according to attributes of the regions, and transmits information on the region which the to-be-updated contents are to be stored and the to-be-updated contents to the apparatus having the storage space through the first communication unit.

The apparatus may further include a second communication unit that is used for communication to a remote contents server, wherein the contents storing unit is a storing unit of the remote contents server, and wherein the control unit receives the to-be-updated contents from the remote contents server through the second communication unit and transmits the to-be-updated contents to the device having the partitioned storage space through the first communication unit.

### BRIEF DESCRIPTION OF THE DRAWINGS

The above and other aspects of the present invention will become more apparent by describing in detail exemplary embodiments thereof with reference to the attached drawings in which:

FIG. 1 is a flowchart showing a contents storing method according to an exemplary embodiment of the present invention;

FIG. 2 is a view showing a partitioned storage space according to an exemplary embodiment of the present invention;

FIG. 3 is a view showing a partitioned storage space according to another exemplary embodiment of the present invention;

FIG. 4 is a view showing a partitioned storage space according to another exemplary embodiment of the present invention;

FIG. 5 is a view showing a partitioned storage space according to another exemplary embodiment of the present invention;

FIG. 6 is a view showing a partitioned storage space according to another exemplary embodiment of the present invention;

FIG. 7 is a view showing a construction of a contents storing apparatus according to an exemplary embodiment of the present invention;

FIG. 8 is a view showing an example of a user interface used for partitioning a storage space according to an exemplary embodiment of the present invention; and

FIG. 9 is a view showing an example of a user interface used for setting an automatic-updating region.

### DETAILED DESCRIPTION OF THE INVENTION

Hereinafter, the present invention will be described in detail by explaining exemplary embodiments of the invention with reference to the attached drawings.

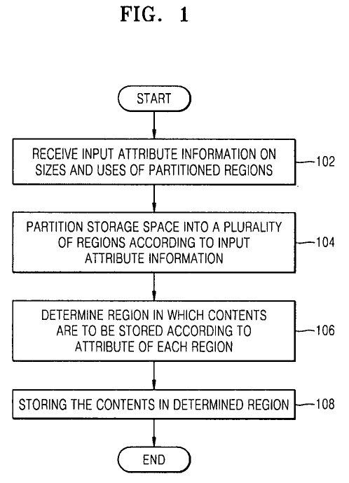

FIG. 1 is a flowchart showing a contents storing method according to an exemplary embodiment of the present invention.

Referring to FIG. 1, a user inputs information required for partitioning a storage space (102). The required information is attribute information including sizes and uses of partitioned regions of the storage space. The attribute information may be information directly input by the user, basic information set in advance in an apparatus, or information modified by the user. The user can partition the storage space into a plurality of regions having desired sizes and designate uses to the partitioned regions. By designation of the sizes and uses, the user can allocate large space to user's favorite genre or artists or selectively perform automatic updating of contents suitable for user's preference. The use is an attribute indicating a region in which contents are to be stored. In addition, the use indicates a manual-updating region or an automatic-updating region. In addition, when a region is the automatic-updating region, the use indicates a condition of the contents which is to be selected and stored.

The contents selection condition includes an attribute of the to-be-stored contents designated in advance. The contents selection condition may be a category or characteristic of the contents or a combination thereof. For example, the contents selection condition may be a condition using at least one of categories of the contents included in meta data of the contents such as date of issue, title, name of album, size, genre, and artist. The contents selection condition may be a condition using at least one of characteristics obtained by analyzing details of the contents such as mood, color, composition, and tempo of the contents. The contents selection condition may also be a condition obtained by partially or entirely combining the information included in the meta data and the information on the details of the contents.

Next, the storage space is partitioned according to the attribute information (104). More specifically, the storage space is virtually partitioned into regions having various sizes, and the use is designated to each region. The designated uses and size of each region are referred to when the contents are to be stored in the partitioned storage space. The designated uses and size are stored as partition information of the storage space.

When the contents are stored or updated, it is determined based on the attribute information which region the contents are to be stored in (106). Contents selected by the user are stored in the manual-updating region. In case of the automatic-updating region, contents suitable for the selection condition of each automatic-updating region are selected from the contents stored in a contents storing unit. In case of a region which the selection condition using the items of the meta data of the contents are designated to, the attribute of the contents are acquired by analyzing the meta data of the contents. In case of a region which the selection condition using the characteristics according to the details of the contents are designated to, the attribute of the contents are acquired by analyzing the details of the contents. After that, it is determined which region has the selection conditions that the acquired attributes of the contents are suitable for. The contents are stored in the determined partitioned region (108). Although the contents are stored in the local storage space in the exemplary embodiment, but the contents may be stored in an external storage space of an external apparatus such as portable media player.

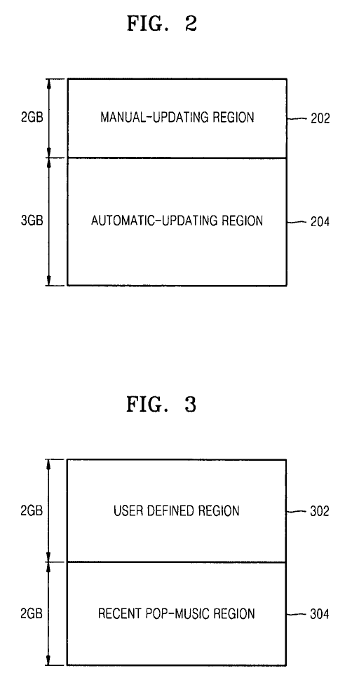

FIG. 2 is a view showing a partitioned storage space according to an exemplary embodiment of the present invention.

Referring to FIG. 2, a 5-gigabyte (GB) storage space is partitioned into two regions, that is, a 2-GB manual-updating region 202 and a 3-GB automatic-updating region 204. In the manual-updating region 202, the contents are selected from a contents list by a user and are downloaded or stored. In the automatic-updating region 204, the contents suitable for a condition designated by the user is automatically selected and are downloaded or stored. The user may designate some or all of the partitioned regions as the manual-updating regions 202 or the automatic-updating regions 204.

FIG. 3 is a view showing a partitioned storage space according to another exemplary embodiment of the present invention.

Referring to FIG. 3, a 4-GB storage space is partitioned into two regions, that is, a 2-GB user defined region 302 and recent pop-music region 304. The user defined region 302 is a manual-updating region in which the contents manually selected by the user are stored. The recent pop-music region 304 is an automatic-updating region in which the contents are stored within a specified number of days from an issue date of the contents. For example, pop-music within one month from the issue date may be defined as a recent pop-music by the user. The time interval may be defined by using default information of an apparatus. As partition attribute information on the recent pop-music region 304, a size of 2-GB is stored, and uses of automatic updating and storing of domestic pop music contents within one month from the issue date is stored. For the attribute of the contents, meta data of the contents may be used. The meta data is analyzed, so that a content file having the appropriate attributes is automatically stored in the recent pop music region 304.

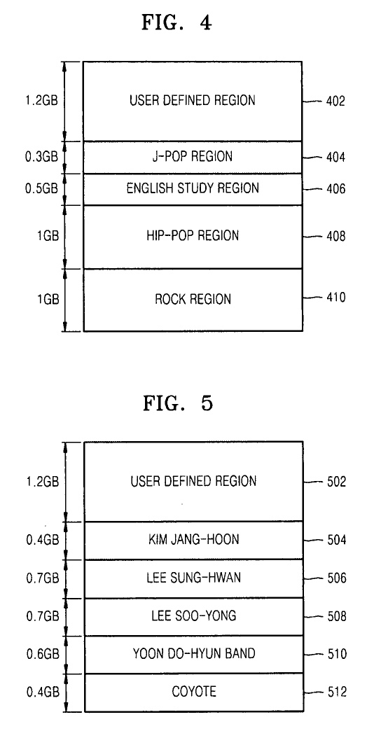

FIG. 4 is a view showing a partitioned storage space according to another exemplary embodiment of the present invention.

Referring to FIG. 4, a 4-GB storage space is partitioned into one user defined region 402 as a manual-updating region and four automatic-updating regions 404 to 410. For the four automatic-updating regions 404 to 410, categories are designated as selection conditions of to-be-stored contents, and the categories include different genres. The user allocates much more size to the hip-pop region 408 and the rock region 410 corresponding to the user's preferred genres of hip-pop and rock than to the regions corresponding to other genres.

FIG. 5 is a view showing a partitioned storage space according to another exemplary embodiment of the present invention.

Referring to FIG. 5, a 4-GB storage space is partitioned into one user defined region 502 for manual updating and five automatic-updating regions 504 to 512. The five automatic-updating regions 504 to 512 are designated with categories as selection conditions of to-be-stored contents. As shown in FIG. 5, the five automatic-updating regions 540 to 512 are designated with different artists as the categories.

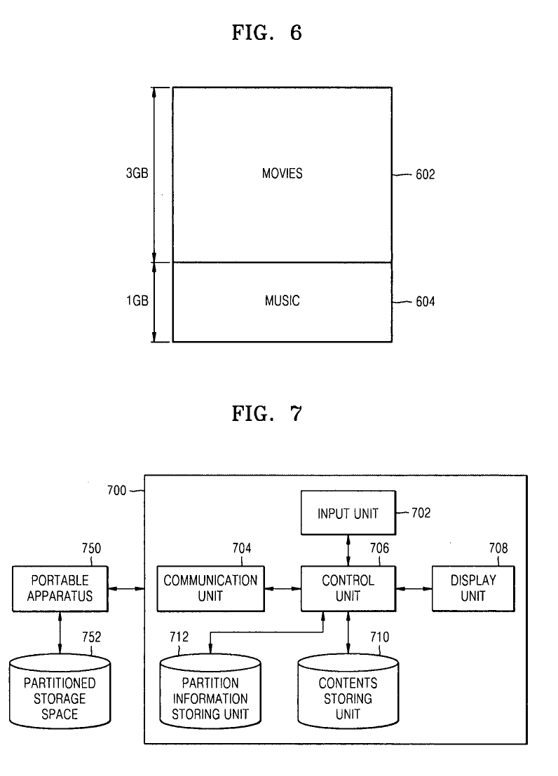

FIG. 6 is a view showing a partitioned storage space according to another exemplary embodiment of the present invention.

Referring to FIG. 6, the 4-GB storage space is partitioned into automatic-updating regions 602 and 604. The automatic-updating regions are a 3-GB movie contents region 602 and a 1-GB music contents region 604.

FIG. 7 is a view showing a construction of a contents storing apparatus 700 according to an exemplary embodiment of the present invention.

Referring to FIG. 7, a contents storing apparatus 700 according to the exemplary embodiment of the present invention is a PC or an electronic appliance embedded with updating software (a media transmission program) and a media library. The contents storing apparatus 700 transmits contents to a portable apparatus 750 such as a portable media player connected through a communication unit 704 such as a universal serial bus (USB) and controls the portable apparatus 750 to store the contents in a storage space 752. A control unit 706 of the contents storing apparatus 700 partitions a storage space 752 of the portable apparatus 750 according to a user's settings, determines which regions the contents of a contents storing unit 710 are stored in according to the attributes of the partitioned regions, and transmits the contents to manually or automatically update the contents.

While referring to a user interface for the updating software shown in a display unit 708, a user inputs the number of the partitioned regions and attribute information on sizes and uses of the partitioned regions through an input unit 702. The control unit 706 virtually partitions the storage space 72 of the portable apparatus 750 into the user's desired number and sizes, and after that, designates the uses to each partitioned region. As described above, the uses includes types of the regions (i.e., manual and automatic-updating regions), and information on selection condition such as categories of the to-be-updated contents in case of the automatic-updating region. The information on the sizes and uses of the partitioned regions of the storage space 752 is stored as partition information in the partition information storing unit 712. The information is referred to at the time of transmitting or updating contents.

When the connection of the portable apparatus 750 to the contents storing apparatus 700 is detected, the control unit 706 executes the updating software to perform the manual or automatic contents updating. When the user selects the contents from a displayed contents list on a window for the updating software and performs updating, the control unit 706 transmits and stores the selected contents and a command for storing the selected contents in the user defined manual-updating region to the portable apparatus 750. For the storage space set as an automatic-updating region, the control unit 706 prepares the contents suitable for the attribute information of the region so as to have a size smaller than the size of the region and transmits and stores the contents to the portable apparatus 750.

The contents storing unit 710 may include a separate storing unit provided to a remote contents server (not shown). In this case, the contents storing apparatus 700 includes a second communication unit (not shown) for communication to the remote contents server. The consents storing apparatus 700 receives to-be-updated contents and transmits the contents to the portable apparatus 750 through the second communication unit.

FIG. 8 is a view showing an example of a user interface used for partitioning a storage space according to an exemplary embodiment of the present invention, wherein the user interface is implemented on a PC in a software manner.

Referring to FIG. 8, a currently-set partitioned state 808 of a storage space is displayed. In the partitioned state 808, types of the updating regions(manual or automatic-updating regions) and sizes of the partitioned regions are displayed. In addition, selection conditions or used amount of each region may be displayed. The user may use an “add new partition” button 802 to add a new partitioned region and define the added region as an automatic-updating region. In addition, the user may use a “remove partition” button 804 to remove an existing partitioned region and change the region into a manual-updating region. In addition, the user may use a “change definition of partition” button 806 to change the previously-defined partitioned region. More specifically, the user may change the sizes of the existing partitioned regions and/or automatic updating settings (contents selection conditions) therefore.

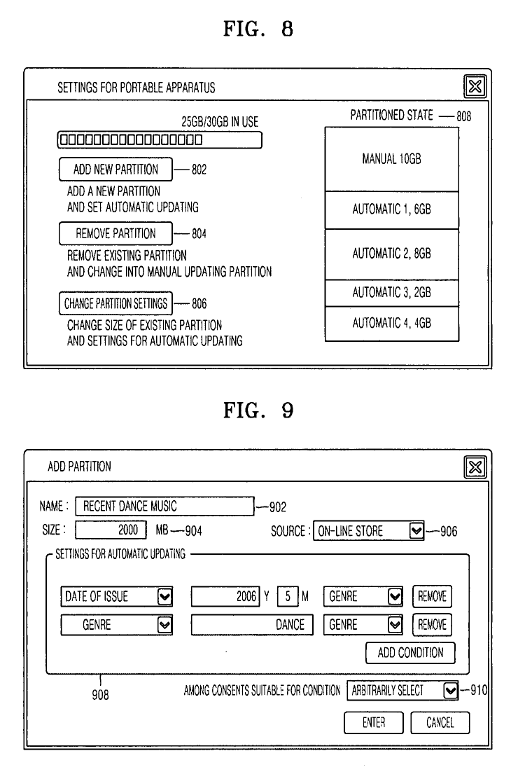

FIG. 9 is a view showing an example of a user interface used for setting an automatic-updating region, wherein a screen displayed by clicking a “add new partition” button 802 in FIG. 8 is shown.

Referring to FIG. 9, the user inputs “name” 902 and “size” 904 of a newly-added partitioned region and input a selection condition of the contents that are to be stored in the partitioned region in an “automatic updating setting” section 908. At this time, a region from which the contents suitable for the selection condition are transmitted may be set. Alternatively, the contents may be transmitted from a contents library of a personal computer (PC). As shown in an example of FIG. 9, the contents may be downloaded from an on-line contents store of a remote contents server, which is called “on-line store” (906). In addition, when a total size of the contents suitable for the selection condition is larger than a size of the partitioned region, a method of selection for to-be-transmitted contents may be set. For example, the contents are sorted by title or artist of contents and some of the contents are selected. As shown in the example of FIG. 9, the contents may be arbitrarily selected within a set size, which is called “arbitrary selection” (910).

The method according to the exemplary embodiment of the present invention can also be embodied as computer readable codes on a computer readable recording medium.

According to the exemplary embodiments of the present invention, a storage space is partitioned according to user's intention, and contents are manually or automatically stored in partitioned regions, so that it is possible to improve convenience for transmission of contents and to actively use an automatic transmission function.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. A method of storing contents according to an attribute of a storage space, the method comprising:
receiving input attribute information on sizes and uses of a plurality of regions;
partitioning the storage space into the plurality of regions according to the input attribute information for each of the plurality of regions;
determining a region in which the contents are to be stored according to the attribute information of each of the plurality of regions; and
storing the contents in the determined region.

2. The method of claim 1, wherein the partitioning comprises designating at least one of the plurality of regions as an automatic-updating region.

3. The method of claim 2, wherein the designating at least one of the regions as the automatic-updating region comprises designating selection conditions of contents which are to be stored in the automatic-updating region.

4. The method of claim 1, wherein the determining the region in which the contents are to be stored comprises:
acquiring an attribute of the contents with reference to meta data of the contents; and
determining which one of the plurality of regions has selection conditions corresponding to the acquired attribute of the contents.

5. The method of claim 4, wherein the selection conditions of the contents to be stored comprise at least one of a date of issue, a title, a name of an album, a size, a genre, and an artist.

6. The method of claim 3, wherein the determining the region in contents are to be stored comprises:
acquiring attributes of contents by analyzing details of the contents; and
determining which one of the plurality of regions has the selection conditions corresponding to the acquired attributes of the contents.

7. The method of claim 6, wherein the selection conditions of the contents to be stored comprise at least one of a mood, a color, and a composition.

8. The method of claim 2, wherein the partitioning comprises designing at least one of the plurality of regions as a manual-updating region.

9. The method of claim 8, wherein the determining the region in which the contents are to be stored comprises determining that the contents manually selected by a user are stored in the manual-updating region.

10. The method of claim 1, wherein the determining the region in contents are to be stored comprises:
detecting a connection to an apparatus having the partitioned storage space; and
determining contents to be updated from the contents stored in a contents storing unit and a region in which the contents to be updated are stored according to attribute information of the regions in the contents storing unit, and
wherein the storing of the contents comprises transmitting information on the region where the contents to be updated are stored and the contents to be updated to the connected apparatus.

11. The method of claim 10, wherein the storing the contents further comprises determining the contents to be updated comprises the contents having a size smaller than a size of each of the plurality of portioned regions in which the contents are to be stored.

12. A computer readable recording medium having embodied thereon a computer program for a method of storing contents according to an attribute of a storage space, the method comprising:
receiving input attribute information on sizes and uses of a plurality of regions;
partitioning the storage space into the plurality of regions according to the input attribute information for each of the plurality of regions;
determining a region in which the contents are to be stored according to the attribute information of each of the plurality of regions; and
storing the contents in the determined region.

13. An information recording medium comprising:
at least one automatic-updating region which stores contents which are automatically determined according to sizes and selection conditions of the contents, wherein the sizes and selection conditions of the contents are designated by a user.

14. The information storage medium of claim 13, further comprising a manual-updating region which stores contents which are selected by the user.

15. An apparatus for storing contents according to an attribute of a storage space, the apparatus comprising:
a first communication unit which communicates with a device comprising the storage space;
a contents storing unit which stores the contents;
an input unit which inputs attribute information on sizes and uses of a plurality of regions; and
a control unit which partitions the storage space into the plurality of regions according to the attribute information input through the input unit, determines content to be updated among the contents stored in the contents storing unit and one of the plurality of regions in which the contents to be updated are to be stored according to attributes of the plurality of regions, and transmits information on the region which the contents to be updated are to be stored and the contents to be updated to the device through the communication unit.

16. The apparatus of claim 15, wherein the control unit designates at least one of the plurality of regions as an automatic-updating region.

17. The apparatus of claim 16, wherein the control unit designates a selection condition of contents which are to be stored in the regions for automatically updating the contents.

18. The apparatus of claim 15, wherein the control unit acquires attributes of the contents with reference to meta data stored in the contents storing unit and determines which one of the plurality of regions has the selection conditions corresponding to the acquired attributes of the contents.

19. The apparatus of claim 18, wherein the selection conditions of the contents to be stored are conditions using at least one of a date of issue, a title, a name of an album, a size, a genre, and an artist.

20. The apparatus of claim 17, wherein the control unit acquires attributes of the contents by analyzing details of the contents stored in the contents storing unit and determines which one of the plurality of regions has the selection conditions corresponding to the acquired attributes of the contents.

21. The apparatus of claim 20, wherein the selection conditions of the to-be-stored contents are conditions using at least one of a mood, a color, and a composition.

22. The apparatus of claim 16, wherein the control unit designates at least one of the plurality of regions as a manual-updating region.

23. The apparatus of claim 22, wherein the control unit determines that the contents to be updated manually selected by a user are stored in the manual-updating region.

24. The apparatus of claim 15, wherein the control unit determines that the contents to be updated comprise contents having a size smaller than a size of the region in which the contents to be updated are to be stored.

25. The apparatus of claim 15, further comprising a second communication unit which communicates with a remote contents server,
wherein the contents storing unit is a storing unit of the remote contents server, and
wherein the control unit receives the contents to be updated from the remote contents server through the second communication unit and transmits the contents to be updated to the apparatus having the partitioned storage space through the first communication unit.
